(19) United States
(12) Patent Application Publication
(10) Pub. No.: US 2011/0069158 A1
(43) Pub. Date: Mar. 24, 2011

(54) VIRTUAL WINDOW SYSTEM AND METHOD

(76) Inventors: Dekel Shiloh, New York, NY (US); Naim Avraham Shichrur, Be'er Yaakov (IL)

(21) Appl. No.: 12/886,742

(22) Filed: Sep. 21, 2010

Related U.S. Application Data
(60) Provisional application No. 61/244,162, filed on Sep. 21, 2009.

(51) Int. Cl. H04N 7/18

(52) U.S. Cl. 348/61; 348/E07.085

(57) ABSTRACT

Some embodiments include a virtual window system and method. In some embodiments a virtual window system may include an image capturing device to capture a high definition video image of an outdoor view and to transmit a signal corresponding to the video image; and at least one virtual window display positioned at an indoor location, to receive the signal from the image capturing device and, based on the signal, to display a high definition virtual, window-like, view corresponding to the outdoor view.

### CROSS REFERENCE

This application claims the benefit of and priority from U.S. Provisional Patent application No. 61/244,162, entitled “Virtual Window System and Method”, filed Sep. 21, 2009, the entire disclosure of which is incorporated herein by reference.

### BACKGROUND

An enclosed structure, for example, a building may include different units, sections and/or areas (“building units”), for example, apartments, offices, rooms and the like. Different building units of the same building, or even different areas or rooms within the same building unit, may have fixed views to different outdoor scenes, e.g., depending on a location and/or orientation of a building unit and/or the location of one or more windows in the building unit.

The outdoor scene viewed from a certain location in the building may depend on the line of sight at the location. For example, a first building unit located on a relatively low floor, e.g., the first floor, may have a first window facing a first direction, e.g., east, and a second window facing a second direction, e.g., north. The first window may provide a fixed outdoor view to a first scene, e.g., another building located in front of the first window; while the second window may provide a fixed outdoor view to a second scene, e.g., a park. A second building unit may be similar to the first building unit, except for the fact that the second building unit is located on a relatively high floor, e.g., the thirtieth floor, which may be higher than the other building. Accordingly, a first window of the second building unit facing the first direction may provide a fixed outdoor view to a third scene, e.g., a forest, monument, or seashore located behind the other building; and a second window of the second building unit may provide a different outdoor view, e.g., a bird's-eye view of the second scene. A third building unit located on the first floor may have a window facing a third direction, e.g., west, which may provide a fixed outdoor view to a fourth scene, e.g., a highway.

The value or “market value” of a building unit may be affected by various parameters, which may include location-related parameters including, for example, a floor on which the building unit is located and/or the direction in which the windows of the building unit are facing. For example, the second building unit described above may have a greater value than the first building unit, due to the view of the forest and/or the bird's-eye view of the park.

Some areas within a building unit (“inner areas”) may not even have a view to an outdoor scene, for example, if the inner areas do not include a portion of an external wall of the building and/or do not have a window facing out of the building.

### SUMMARY

Some demonstrative embodiments may allow providing a certain indoor location, e.g., within a an enclosed structure, e.g., a building, with a virtual, window-like, view.

In some demonstrative embodiments, the virtual view may include a view, which would have been viewed from a window, if the window had been located at the certain location. For example, the virtual view may provide a user of an enclosed structure, e.g., a building unit, with window-like view at a certain location in the enclosed structure, e.g., a wall, floor or ceiling, which may not be equipped with an actual window.

In some demonstrative embodiments, the virtual view may be different from an actual view provided by a line of view at the certain location or at an outdoor location proximal to the certain location, e.g., a view, which would have been seen looking out of a real window at the certain location.

In some demonstrative embodiments, the virtual view may include a view of a scene, which may be viewed from another location in the same building.

In some demonstrative embodiments, the virtual view may include a view of a scene, which may be viewed from a high floor and/or the rooftop of the building.

In some demonstrative embodiments, the virtual view may include a view of a scene, which may be viewed from different floors of the building and/or in different directions.

In some demonstrative embodiments, the virtual view may include a different view of the same scene as the actual view. For example, a user of a building unit facing a certain scene from a first floor of a building may be provided with a virtual view including a view of the certain scene from a second, different, floor of the building.

In some demonstrative embodiments, the virtual view may include a view of a scene different from the scene of the actual view. For example, a user of a building unit facing a first direction, e.g., east, may be provided with a virtual view including a view of a scene in a second direction, e.g., north.

In one example, the first building unit described above may be provided with a virtual window-like view of the forest, e.g., similar to the view from the first window of the second building unit; a virtual window-like view of the park, e.g., similar to the view from the second window of the second building unit; and/or virtual window-like view of the highway, e.g., similar to the view from the window of the third building unit.

In some demonstrative embodiments, the virtual view may include a view of a scene, which may be viewed from another location in the same building unit. For example, an inner area, e.g., an inner room, of the first building unit described above may be provided with a virtual window-like view similar to the view from the first window of the first building unit; a virtual window-like view of the forest, e.g., similar to the view from the first window of the second building unit; a virtual window-like view of the park, e.g., similar to the view from the second window of the second building unit; and/or virtual window-like view of the highway, e.g., similar to the view from the window of the third building unit.

In some demonstrative embodiments, the virtual view may include a view of a scene, which may be viewed from a relatively close neighborhood of the building, for example, a scene viewed from a location within a radius of no more than one kilometer, for example, no more than 500 meters, e.g., no more than 100 meters, from the certain location. For example, the virtual view may include a view of a scene viewed from another building, e.g., a taller building, located in the neighborhood of the building, and the like.

In some demonstrative embodiments, the virtual view may include a continuous or substantially continuous view of the scene, for example, a video or video-like view of the scene.

In some demonstrative embodiments, the virtual view may include a real time view of the scene. The term “real time view” as used herein with relation to a scene may refer to a real time, substantially real time, live, substantially live, actual, substantially actual, simultaneous, substantially simultaneous, immediate and/or substantially immediate, view of a scene. Such real time virtual view of the scene may provide a user, e.g., a viewer of the virtual window-like view, with a sense of looking out a real window at a real-time scene.

In other embodiments the virtual view may include any suitable delayed view of the scene.

Some demonstrative embodiments include a virtual-window display (“virtual window”) positioned on a wall, floor and/or ceiling, at an indoor location, and a video capturing device positioned to capture a video image of an outdoor scene, and to communicate the video image of the outdoor scene to the virtual window.

In some demonstrative embodiments, the virtual window may display the outdoor scene in a window-like view or in any other suitable format.

In some demonstrative embodiments, the virtual window may include any suitable device and/or system capable of displaying a video image in a window-like fashion, e.g., such that a viewer of the video image may be under the impression that the displayed video image is an actual scene viewed through an actual window.

The image-capturing device may include one or more suitable video cameras, e.g., suitable High-Definition (HD) video cameras, positioned to capture a desired view of an outdoor scene.

The virtual window may communicate with the video-capturing device via any suitable wired or wireless communication link.

Some demonstrative embodiments may include a “view-on-demand” system capable of providing a plurality of users with one or more virtual window views, in response to one or more requests or demands received from the users. For example, the view-on-demand system may include a set of video capturing devices positioned to capture a plurality of views of a plurality of outdoor scenes. A user of a virtual window may select a desired view from the plurality of views; the video image of the selected view may be communicated form the corresponding video capturing device to the virtual window, which may display the selected view.

Some demonstrative embodiments include a virtual window system capable of providing the user of a virtual window with a virtualization of any additional sensation, feeling, and/or impression, e.g., sound, scent, and the like, corresponding to the image of a scene displayed by the virtual window.

In some demonstrative embodiments, a virtual window system may include an image capturing device to capture a high definition video image of an outdoor view and to transmit a signal corresponding to the video image; and at least one virtual window display positioned at an indoor location, to receive the signal from the image capturing device and, based on the signal, to display a high definition virtual, window-like, view corresponding to the outdoor view.

In some demonstrative embodiments, the virtual view simulates a view through an actual window.

In some demonstrative embodiments, the virtual window display is to controllably adjust the virtual view based on an orientation of a user relative to the virtual window display.

In some demonstrative embodiments, the virtual window display includes at least one sensor to sense the orientation of the user relative to the virtual window display, and a controller to controllably adjust the virtual view based on the sensed orientation.

In some demonstrative embodiments, the virtual view corresponds to a substantially real-time view of an outdoor scene.

In some demonstrative embodiments, the outdoor view corresponds to an outdoor field of view in a direction from an outdoor location proximal to the indoor location.

In some demonstrative embodiments, the virtual window display is positioned on an inner-facing surface of an enclosed structure, and the capturing device is positioned on an outer-facing surface of the enclosed structure.

In some demonstrative embodiments, the outdoor scene includes a scene viewed from another location within a radius of less than one kilometer of the indoor location.

In some demonstrative embodiments, the image-capturing device is positioned at a location higher than the indoor location.

In some demonstrative embodiments, the indoor location includes a first location within a building and wherein the other location includes a second location within the building.

In some demonstrative embodiments, the at least one image capturing device includes a plurality of image capturing devices located to capture video images of a plurality of different outdoor scenes, and wherein the virtual window display includes a user interface to allow a user to select an outdoor scene to be displayed by the virtual display device.

In some demonstrative embodiments, the virtual window display includes a user interface to allow a user to control one or more image-capturing attributes of the image-capturing device.

In some demonstrative embodiments, the image-capturing device is to transmit the signal to the virtual window display via a wireless communication link.

In some demonstrative embodiments, the system includes an audio capturing device to capture a sound at the outdoor scene, wherein the virtual window display includes an audio scent generator to generate a sound corresponding to the sound at the outdoor scene.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a virtual-window system in accordance with some demonstrative embodiments.

FIG. 2 is a schematic block diagram illustration of a virtual-window display in accordance with some demonstrative embodiments.

FIG. 3 is a schematic block diagram illustration of an image-capturing device in accordance with some demonstrative embodiments.

FIG. 4 is a schematic block diagram illustration of an image-capturing deployment scheme in accordance with some demonstrative embodiments.

FIG. 5 is a schematic block diagram illustration of a virtual-window display deployment scheme in accordance with some demonstrative embodiments.

### DETAILED DESCRIPTION

In the following detailed description, numerous specific details are set forth in order to provide a thorough understanding of some demonstrative embodiments. However, it will be understood by persons of ordinary skill in the art that some demonstrative embodiments may be practiced without these specific details. In other instances, well-known methods, procedures, components, units and/or circuits have not been described in detail so as not to obscure the discussion.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein includes, for example, “multiple” or “two or more”. For example, “a plurality of items” includes two or more items.

Some demonstrative embodiments may include one or more wired or wireless links, may utilize one or more components of wireless communication, may utilize one or more methods or protocols of wireless communication, or the like. Some demonstrative embodiments may utilize wired communication and/or wireless communication.

Some embodiments may be used in conjunction with various devices and systems, for example, a video device, an audio device, an audio-video (A/V) device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a data source, a data sink, a Digital Still camera (DSC), a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a wired or wireless network, a wireless area network, a Wireless Video Are Network (WVAN), a Local Area Network (LAN), a Wireless LAN (WLAN), a Personal Area Network (PAN), a Wireless PAN (WPAN), devices and/or networks operating in accordance with existing WirelessHD™ and/or Wireless-Gigabit-Alliance (WGA) specifications and/or future versions and/or derivatives thereof, devices and/or networks operating in accordance with existing IEEE 802.11 (IEEE 802.11-1999: Wireless LAN Medium Access Control (MAC) and Physical Layer (PHY) Specifications), 802.11a, 802.11b, 802.11g, 802.11h, 802.11j, 802.11n, 802.16, 802.16d, 802.16e, 802.16f, standards and/or future versions and/or derivatives thereof, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device (e.g., BlackBerry, Palm Treo), a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, Enhanced Data rates for GSM Evolution (EDGE), or the like. Other embodiments may be used in various other devices, systems and/or networks.

Some demonstrative embodiments may be used in conjunction with suitable limited-range or short-range wireless communication networks, for example, “piconets”, e.g., a wireless area network, a WVAN, a WPAN, and the like.

Some embodiments may be implemented for wireless transmission of suitable content between two or more devices. In one embodiment, the content may include media content, for example, audio and/or video content, e.g., High Definition Television (HDTV) content, and the like. In other embodiments, the content may include any other suitable data, information and/or signals.

Some demonstrative embodiments include systems and/or methods, which may allow providing a certain location within a building with a virtual, window-like, view.

In some demonstrative embodiments, the virtual view may be similar to or substantially identical to an actual view provided by a line of view at the certain location and/or a line of view at a location proximal to the certain location, e.g., a view, which would have been seen looking out of a real window at the certain location; while in some demonstrative embodiments, the virtual view may be different from the actual view, e.g., as described below.

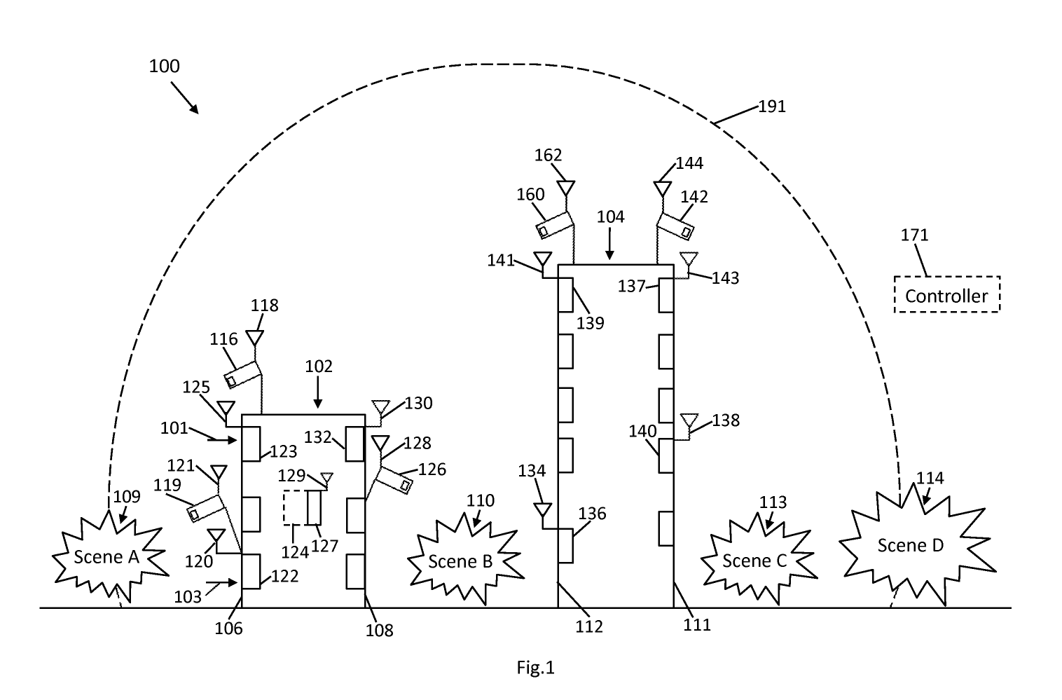

Reference is now made to FIG. 1, which schematically illustrates a virtual window system 100 deployed to provide window-like views of outdoor scenes of a neighborhood 191, in accordance with some demonstrative embodiments.

In some demonstrative embodiments, neighborhood 191 may include an area confined within a circle having a radius of less than one kilometer, for example, less than 500 meters, e.g., less than 100 meters. In other embodiments, neighborhood 191 may include any other, larger or smaller, area.

Some demonstrative embodiments are described herein with reference to a building, a building unit, and the like. However, it will be appreciated that other embodiments may be implemented with respect to any other suitable enclosed structure.

Neighborhood 191 may include one or more enclosed structures, for example, one or more buildings, e.g., a first building 102, and a second building 104, which may be taller than building 102.

In some demonstrative embodiments, a first side wall 106 of building 102 may face a first direction, e.g., east, while a second side wall 108 of building 102 may face a second direction, e.g., west. A first sidewall 112 of building 104 may face wall 108, while a second sidewall 111 of building 104 may face the second direction, e.g., west. In other embodiments, buildings 102 and/or 104 may have any other suitable orientation.

In some demonstrative embodiments, different building units, e.g., apartments, rooms and/or offices, of buildings 102 and 104 may have fixed actual lines of sight to different views and/or different outdoor scenes, e.g., depending on the location and/or orientation of the building units and/or the location of one or more windows in the building units. For example, building units bordering on wall 106 and/or having a window in wall 106 may have a fixed actual line of sight (also referred to as “line of view”) to a first outdoor scene 109 (“scene A”), while building units bordering on wall 108 and/or having a window in wall 108 may have a fixed actual line of view to a second outdoor scene (“scene B”) and/or building 104.

In some demonstrative embodiments, a building unit on a first floor 103 of building 102 may have a first fixed actual view of scene 109, while a building unit on another floor 101, e.g., higher than floor 103, may have a second, different, fixed actual view of scene 109. For example, the building unit on floor 103 may have a relatively close and/or detailed view of scene 109, while the building unit on floor 101 may have a relatively far and/or less detailed view, e.g., a bird's-eye view, of scene 109.

In some demonstrative embodiments, building units bordering on wall 112 of building 104 and/or having a window in wall 112 may have a fixed actual line of sight to scene 110 and/or building 102, while building units bordering on wall 111 and/or having a window in wall 111 may have a fixed actual line of sight to a third outdoor scene 113 (“scene C”) and/or a fourth outdoor scene 114 (“scene D”). For example, building units bordering on wall 111 at relatively high floors of building 104 may have a fixed actual view of both scenes 113 and 114, while building units bordering on wall 111 at relatively low floors of building 104 may have a fixed view of scene 113 only. Building units bordering on wall 112 at relatively high floors of building 104 may have a fixed actual view of both scenes 110 and 109, while building units bordering on wall 111 at relatively low floors of building 104 may have a fixed actual view of scene 110 only.

In some demonstrative embodiments, one or more building units of buildings 102 and/or 104 may not have an actual line of sight to any outdoor scene. For example, a building unit 124 may not border on any sidewall of building 102 and/or may not have any external window and, therefore, may not have an actual view of any outdoor scene.

In some demonstrative embodiments, a virtual window system 100 may be deployed in neighborhood 191 to provide a user located in a certain location within building 102 and/or building 104 with a virtual, window-like, view, which may be similar to, or different from, an actual view provided by an actual line of sight at the certain location of the user, e.g., a view which would have been seen looking out of a real window at the certain location, as described in detail below.

In some demonstrative embodiments, system 100 may include one or more image-capturing devices capable of capturing video images of different views of scenes within the neighborhood 191. For example, a capturing device 116 may be positioned on a rooftop of building 102 to capture video images of views of scene 109 and/or any other suitable view and/or scene; a capturing device 126 may be positioned on sidewall 108 to capture video images of views of scene 110 and/or any other suitable view and/or scene; a capturing device 160 may be positioned on a rooftop of building 104 to capture views of scene 110 and/or scene 109 and/or any other suitable view and/or scene; and/or a capturing device 142 may be positioned on the rooftop of building 104 to capture views of scene 113 and/or scene 114 and/or any other suitable view and/or scene.

In some demonstrative embodiments, at least one capturing device of capturing devices 116, 126, 160 and/or 142 may include one or more suitable video cameras, e.g., suitable High-Definition (HD) video cameras, positioned to capture a desired view of outdoor scenes of neighborhood 191.

In some demonstrative embodiments, image capturing devices capturing devices 116, 126, 160 and/or 142 may be configured to capture a high definition video images of outdoors view and to transmit a signal corresponding to the video image, e.g., as described below.

In some demonstrative embodiments, a high definition video image may include a video image, e.g., a sequence of video frames, having a relatively high resolution, for example, a resolution of at least one million pixels per video frame, e.g., at least two million pixels per frame.

In some demonstrative embodiments, the video image may include a HDTV video image or a video image of any other suitable high-definition format.

In some demonstrative embodiments, the high-definition video image may include a video image having attributes, e.g., resolution, frame frequency, and the like, suitable for displaying a window-like view, e.g., as described below.

In some demonstrative embodiments, system 100 may include at least one virtual window display (“virtual window” or “virtual window device”) positioned at an indoor location, to receive the signal from the image capturing device and, based on the signal, to display a high definition virtual, window-like, view corresponding to the outdoor view, e.g., as described in detail below.

In some demonstrative embodiments, the virtual window may be configured to display the virtual view simulating a view through an actual window.

In some demonstrative embodiments, the virtual window display may be configured to controllably and/or automatically adjust the virtual view based on an orientation of a user relative to the virtual window display. For example, the virtual window display may include at least one suitable sensor to sense the orientation of the user relative to the virtual window display, and a controller to controllably adjust the virtual view based on the sensed orientation, e.g., as described below.

In some demonstrative embodiments, system 100 may include one or more virtual window displays positioned at an indoor location, e.g., on a wall, a floor or a ceiling. For example, a virtual window 122 may be positioned at floor 103, e.g., on wall 106; a virtual window 123 may be positioned at floor 101, e.g., on wall 106; a virtual window 132 may be positioned at floor 101, e.g., on wall 108; a virtual window 127 may be positioned within building unit 124, e.g., on a wall of building unit 124; a virtual window 136 may be positioned at a relatively low floor of building 104, e.g., on wall 112; a virtual window 139 may be positioned at a relatively high floor of building 104, e.g., on wall 112; a virtual window 143 may be positioned at a relatively high floor of building 104, e.g., on wall 111; and/or a virtual window 140 may be positioned at a relatively low floor of building 104, e.g., on wall 111.

In some demonstrative embodiments, virtual windows 122, 123, 132, 127, 139, 137, 136 and/or 140 may communicate with one or more of capturing devices 116, 126, 160, 119 and/or 142 to receive from capturing devices 116, 126, 160, 119 and/or 142 video images of outdoor scenes captured by devices 116, 126, 160, 119 and/or 142.

In some demonstrative embodiments, virtual windows 122, 123, 132, 127, 139, 137, 136 and/or 140 may communicate with one or more of capturing devices 116, 126, 160, 119 and/or 142 via any suitable wired or wireless communication link and/or according to any suitable wired or wireless communication protocol. In one example, virtual windows 122, 123, 132, 127, 139, 137, 136 and/or 140 may communicate with one or more of capturing devices 116, 126, 160, 119 and/or 142 using a suitable wireless video communication protocol, e.g., capable of wirelessly communicating HD video data. For example, image-capturing devices 116, 126, 160, 119 and/or 142 may include one or more suitable antennas 118, 128, 162, 121 and/or 144, respectively; and/or virtual windows 122, 123, 132, 127, 139, 137, 136 and/or 140 may include one or more suitable antennas 120, 125, 130, 129, 141, 143, 134 and/or 138. The wireless video communication protocol may be, for example, in accordance with existing WirelessHD™ and/or Wireless-Gigabit-Alliance (WGA) specifications and/or future versions and/or derivatives thereof; the wireless communication protocol described by US Patent Application Publication No. US2007/0098063 to Reznic et al., published May 3, 2007; and/or US Patent Application Publication No. US2009/0049501 to Freundlich et al., published Feb. 19, 2009, or any other suitable wireless communication protocol.

In some demonstrative embodiments, virtual windows 122, 123, 132, 127, 139, 137, 136 and/or 140 may display the outdoor scenes received from capturing devices 116, 126, 160, 119 and/or 142 in a window-like view or in any other suitable format.

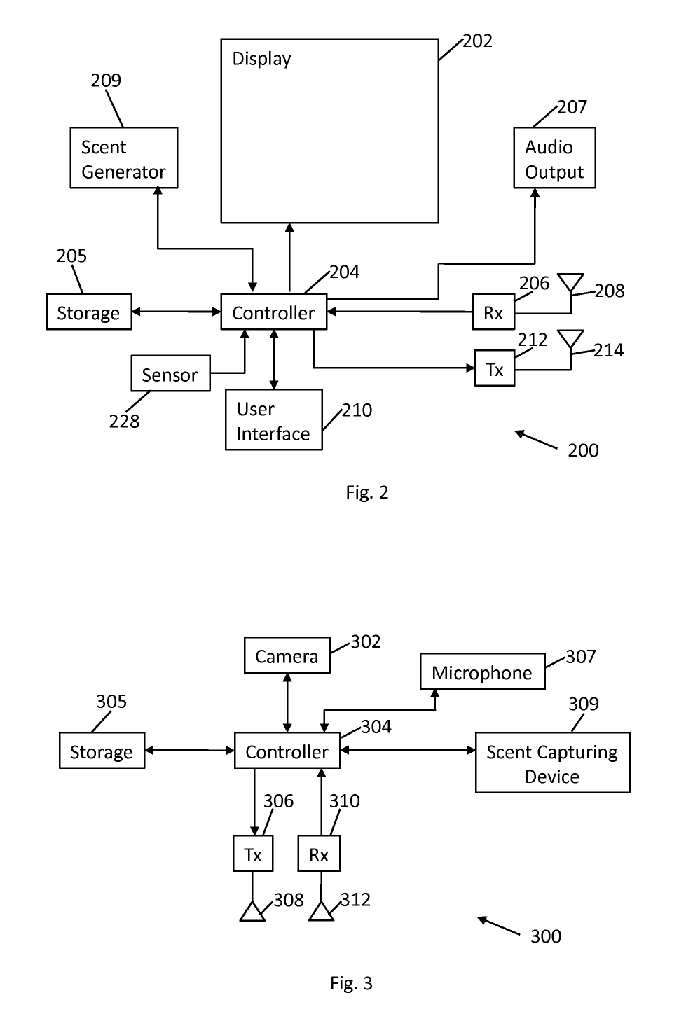

In some demonstrative embodiments, virtual windows 122, 123, 132, 127, 139, 137, 136 and/or 140 may include any suitable device and/or system, e.g., as described below with reference to FIG. 2, capable of displaying a video image in a window-like fashion, e.g., such that a viewer of the video image may be under the impression that the displayed video image is an actual scene viewed through an actual, real, window.

In some demonstrative embodiments, at least one virtual window of virtual windows 122, 123, 132, 127, 139, 137, 136 and/or 140 may provide a virtual, window-like, view which is similar to, or different from, an actual view provided by a line of view at the locations of the virtual windows and/or at outdoor locations proximal to the locations of the virtual windows, e.g., a view which would have been seen looking out of a real window at the location of the virtual window.

In some demonstrative embodiments, at least one virtual window of virtual windows 122, 123, 132, 127, 139, 137, 136 and/or 140 may be positioned on an inner-facing surface of an enclosed structure, and the capturing device may be positioned on an outer-facing surface of the enclosed structure.

In some demonstrative embodiments, at least one virtual window of virtual windows 122, 123, 132, 127, 139, 137, 136 and/or 140 may be located at a certain location, e.g., a wall, ceiling and/or floor, of an enclosed structure, to provide a virtual, window-like, view, which would have been viewed from an actual window, if the actual window had been located at the certain location.

For example, a building unit on floor 103 may not be equipped with an actual window on wall 106, the actual window may be relatively small and/or the actual window may have an unsuitable and/or sub-optimal location, size and/or orientation. According to this example, virtual window 122 may be located on wall 106 to provide a user of the building unit with a virtual window-like view, similar to a view, which would have been viewed from an actual window having the location, size and/or orientation of virtual window 122. For example, a capturing device 119 may be located on wall 106, e.g., outside of the building unit, to capture a scene, which would have been viewed from an actual window having the location, size and/or orientation of virtual window 122.

In some demonstrative embodiments, the virtual view may include a view of a scene, which may be viewed from another location in the same building in which the virtual window is located.

In some demonstrative embodiments, the virtual view may include a view of a scene, which may be viewed from different floors of the building and/or in different directions.

For example, virtual window 122 may communicate with capturing device 116 to receive and display a birds-eye view of scene 109, as captured by capturing device 116; virtual window 122 may communicate with capturing device 126 to receive and display a view of scene 110, as captured by capturing device 126; virtual window 132 may communicate with capturing device 116 to receive and display the birds-eye view of scene 109, as captured by capturing device 116; virtual window 132 may communicate with capturing device 126 to receive and display the view of scene 110, as captured by capturing device 126; virtual window 127 may communicate with capturing device 116 to receive and display the birds-eye view of scene 109, as captured by capturing device 116; virtual window 127 may communicate with capturing device 126 to receive and display the view of scene 110, as captured by capturing device 126; virtual window 136 may communicate with capturing device 160 to receive and display a birds-eye view of scene 110, as captured by capturing device 160; virtual window 136 may communicate with capturing device 142 to receive and display a view of scene 114 or scene 113, as captured by capturing device 142; virtual window 139 may communicate with capturing device 160 to receive and display the birds-eye view of scene 110, as captured by capturing device 160; virtual window 139 may communicate with capturing device 142 to receive and display the view of scene 114 or scene 113, as captured by capturing device 142; virtual window 140 may communicate with capturing device 160 to receive and display the birds-eye view of scene 110, as captured by capturing device 160; virtual window 140 may communicate with capturing device 142 to receive and display the view of scene 114 or scene 113, as captured by capturing device 142; virtual window 137 may communicate with capturing device 160 to receive and display the birds-eye view of scene 110, as captured by capturing device 160; and/or virtual window 137 may communicate with capturing device 142 to receive and display the view of scene 114 or scene 113, as captured by capturing device 142.

In some demonstrative embodiments, the virtual view may include a view of a scene, which may be viewed from a high floor and/or the rooftop of the building. For example, virtual windows 122, 123, 132, 127, 136, 137, 139 and/or 140 may communicate with one or more of capturing devices 116, 160 and/or 142 to receive and display the views captured by capturing devices 116, 160 and/or 142.

In some demonstrative embodiments, the virtual view may include a different view of the same scene as the actual view. For example, virtual windows 122 and/or 123 may communicate with capturing device 116 to receive and display a view of scene 109, as captured by capturing device 116, which may be different from the views of scene 109, as viewed from the location of virtual windows 122 and 123, respectively; virtual window 132 may communicate with capturing device 126 to receive and display a view of scene 110, as captured by capturing device 126, which may be different from the view of scene 110, as viewed from the location of virtual window 132; virtual windows 139 and/or 136 may communicate with capturing device 160 to receive and display a view of scene 110, as captured by capturing device 160, which may be different from the views of scene 110, as viewed from the location of virtual windows 139 and 136, respectively; and/or virtual windows 137 and/or 140 may communicate with capturing device 142 to receive and display a view of scene 113 or scene 114, as captured by capturing device 142, which may be different from the views of scene 113 or 114, as viewed from the location of virtual windows 137 and 140, respectively.

In some demonstrative embodiments, the virtual view may include a view of a scene different from the scene of the actual view. For example, virtual windows 122 and/or 123 may communicate with capturing devices 126, 162 and/or 142 to receive and display views of scenes 110, 113 and/or 114, as captured by capturing devices 126, 162 and/or 142, which may be different from the views of scene 109 available from the location of virtual windows 122 and 123; virtual windows 132, 139, 136, 137 and/or 140 may communicate with capturing device 116 to receive and display views of scene 109, as captured by capturing device 116, which may be different from the views of scenes 110, 113 and/or 114 available from the location of virtual windows 132, 139, 136, 137 and/or 140; and/or virtual windows 137 and/or 140 may communicate with capturing device 160 to receive and display views of scene 110, as captured by capturing device 160, which may be different from the views of scenes 113 and/or 114 available from the location of virtual windows 137 and/or 140.

In some demonstrative embodiments, the virtual view may include a view of a scene, which may be viewed from another location in the same building or building unit in which the virtual window is located. For example, virtual window 127, which may be located in an inner area, e.g., an inner room, may communicate with capturing device 126, which may be located on the same floor as virtual window 124, to receive and display the view captured by capturing device 126. Additionally or alternatively, virtual window 124 may display any other suitable view, e.g., captured by capturing devices 116, 160 and/or 142.

In some demonstrative embodiments, capturing devices 116, 126, 160, 119 and/or 142 may be capable of providing virtual windows 122, 123, 132, 127, 139, 137, 136 and/or 140 with a continuous or substantially continuous view of the scene, as captured by capturing devices 116, 126, 160, 119 and/or 142. For example, capturing devices 116, 126, 160 and/or 142 may provide a video or video-like view of the scene.

In some demonstrative embodiments, the virtual view may include a real time view of the scene. The term “real time view” as used herein with relation to a scene may refer to a real time, substantially real time, live, substantially live, actual, substantially actual, simultaneous, substantially simultaneous, immediate and/or substantially immediate, view of a scene. Such real time virtual view of the scene may provide a user, e.g., a viewer of the virtual window-like view, with a sense of looking out a real window at a real-time scene.

In other embodiments the virtual view may include any suitable delayed view of the scene.

In some demonstrative embodiments, system 100 may include a “view-on-demand” system capable of providing a plurality of users with one or more virtual window views, in response to requests or demands received from the users. For example, virtual windows 122, 123, 132, 127, 139, 137, 136 and/or 140 may include any suitable controller and/or user interface, e.g., as described below with reference to FIG. 2, to receive from a user a selected desired view a plurality of views of the outdoor scenes captured by capturing devices 116, 126, 160, 119 and/or 142. Virtual windows 122, 123, 132, 127, 139, 137, 136 and/or 140 may request from capturing devices 116, 126, 160, 119 and/or 142 the selected view, the selected view may be communicated form the corresponding video capturing device to the virtual window, which may display the selected view. For example, virtual window 122 may provide a user with a list or a preview of a plurality of available views, e.g., from one or more of capturing devices 116, 126, 160, 119 and/or 142; receive from the user an indication of a selected view of the plurality of views; communicate a request to a selected capturing device of capturing devices 116, 126, 160, 119 and/or 142 corresponding to the selected view; and to receive and display the selected view from the selected capturing device.

In some demonstrative embodiments, one or more of virtual windows 122, 123, 132, 127, 139, 137, 136 and/or 140 may allow the user to control one or more image-capturing attributes of capturing devices 116, 126, 160, 119 and/or 142. For example, virtual windows 122, 123, 132, 127, 139, 137, 136 and/or 140 may include any suitable controller and/or user interface, e.g., as described below with reference to FIG. 2, to allow the user to control the movement, e.g., pan and/or tilt, and/or one or more image capturing attributes, e.g., zoom, contrast, and the like, of one or more of image-capturing devices 116, 126, 160, 119 and/or 142. For example, virtual window 122 may receive from the user a request to move, e.g., tilt and/or pan, capturing device 119 and/or to request capturing device to zoom-in or zoom-out on scene 109; and virtual window 122 may communicate the request to capturing device 119.

In some demonstrative embodiments system 100 may be implemented according to a distributed communication and/or control scheme, e.g., such that virtual windows 122, 123, 132, 127, 139, 137, 136 and/or 140 may communicate directly with capturing devices 116, 126, 160, 119 and/or 142 to directly receive the images captured by devices 116, 126, 160, 119 and/or 142; and/or to directly control the operation of capturing devices 116, 126, 160, 119 and/or 142.

In some demonstrative embodiments, system 100 may be implemented according to a suitable centralized communication and/or control scheme. For example, system 100 may include at least one central controller 171 to control the communication between virtual windows 122, 123, 132, 127, 139, 137, 136 and/or 140 and between capturing devices 116, 126, 160, 119 and/or 142.

In some demonstrative embodiments, controller 171 may include a local controller located within neighborhood 191. For example, controller 171 may be implemented as part of one of virtual windows 122, 123, 132, 127, 139, 137, 136 and/or 140. For example, one of virtual windows 122, 123, 132, 127, 139, 137, 136 and/or 140 may be designated as a “master” or “relay” virtual window capable of controlling and/or relaying or the communications between virtual windows 122, 123, 132, 127, 139, 137, 136 and/or 140 and between capturing devices 116, 126, 160, 119 and/or 142.

In some demonstrative embodiments, controller 171 may include a remote or non-local controller located outside of neighborhood 191. For example, controller 171 may be implemented as part of a suitable “view-on-demand” service. Controller 171 may be capable of communicating with virtual windows 122, 123, 132, 127, 139, 137, 136 and/or 140 via any suitable communication link, e.g., via the Internet. For example, controller 171 may be implemented as an Internet service capable of controlling and/or relaying or the communications between virtual windows and capturing devices of a plurality of neighborhoods, example, including neighborhood 191 as well as one or more other neighborhood, e.g., hundreds or thousands of neighborhoods.

According to these embodiments, controller 171 may provide the users of virtual windows 122, 123, 132, 127, 139, 137, 136 and/or 140 in neighborhood 191 with images captured by capturing devices of other neighborhoods, e.g., according to requests received from the users.

FIG. 2 is a schematic block diagram illustration of a virtual-window 200 in accordance with some demonstrative embodiments. In some demonstrative embodiments, virtual-window 200 may perform the functionality of virtual windows 122, 123, 132, 127, 139, 137, 136 and/or 140 (FIG. 1).

In some demonstrative embodiments, virtual-window 200 may include at least one display 202. In some demonstrative embodiments, display 202 may include a high definition display, for example, a flat panel or thin-panel display, e.g., a plasma display panel, Liquid-Crystal-Display (LCD) panel, Light-Emitting-Diode (LED) display, and the like.

In some demonstrative embodiments, virtual-window 200 may include a controller 204 to communicate with one or more image-capturing devices, e.g., one or more of image-capturing devices 116, 126, 160, 119 and/or 142 (FIG. 1); to receive from the one or more image-capturing devices signals of one or more video images and to control display 202 to display a virtual view corresponding to the video images in a window-like manner.

In some demonstrative embodiments, virtual-window display 200 may generate the virtual view simulating a view through an actual window.

In some demonstrative embodiments, virtual-window display 200 may controllably and/or automatically adjust the virtual view based on an orientation of a user relative to the virtual window display.

In some demonstrative embodiments, virtual-window 200 may also include at least one suitable sensor or detector 228 capable of sensing and/or detecting an orientation, e.g., a movement, direction and/or location, of the user of virtual window 200. For example, controller 204 may control display 202 to display the video image in a window-like manner, e.g., in accordance with a location, direction and/or movement of the user with respect to display 202. For example, controller 204 may control display 202 to increase a zoom level of the virtual view, e.g., if sensor 228 detects a movement of the user towards display 202; and/or controller 204 may control display 202 to adjust the virtual of view according to an angle of the user relative to display 202. Controller 204 may implement any suitable method and/or algorithm for adjusting the virtual view based on the orientation of the user with respect to display 202.

In some demonstrative embodiments, display 202, sensor 228 and/or controller 204 may be implemented, for example, in accordance with the virtual window described by Adrijan S. Radikovic, “A true virtual window”, thesis submitted to the Office of Graduate Studies of Texas A&M University, December 2004; the virtual window described by “Creating a Virtual Window using Image Based Rendering”, Weikop J., Stenholt R., Laursen R., Granum E., Proceedings: 8th Annual International Workshop on Presence (PRESENCE 2005), London, United Kingdom, September 2005; the virtual window described by IJsselsteijn, W. A., et al., “Looking at or looking out: exploring monocular cues to create a see-through experience with a virtual window”, PRESENCE 2006: proceedings of the 8th Annual International Workshop on Presence. (pp. 87-95); and the like.

In some demonstrative embodiments, display 202, sensor 228 and/or controller 204 may include, may be part of, and/or may perform the functionality of the Armas Magic-window system available from Armas Computer Corp, 4F. No. 33, Lane 76, Zui Kuang Rd., Nei Hu, Tapei, Taiwan; the Flex™ wall display, available from Mechdyne Corporate, 11 East Church Street, 4th Floor, Marshalltown, Iowa 50158 USA; and the like.

In some demonstrative embodiments, controller 204 may communicate with the one or more image-capturing devices using any suitable wired or wireless communication link.

In some demonstrative embodiments, virtual-window 200 may include a wireless receiver 206 to receive wireless transmissions from the one or more image-capturing devices in accordance with any suitable wireless communication protocol, e.g., via one or more suitable antennas 208.

In some demonstrative embodiments, virtual-window 200 may include a wireless transmitter 212 to transmit wireless transmissions to the one or more image-capturing devices in accordance with any suitable wireless communication protocol, e.g., via one or more suitable antennas 214.

In some demonstrative embodiments, virtual-window 200 may include a suitable user interface 210 to receive commands from a user of virtual window 200. The commands may include, for example, definitions of a scene to be viewed on display 202, definitions of a capturing device from which the scene is to be received, instructions to the imaging capturing device to modify one or more parameters, e.g., a tilt, pan, zoom, and the like.

In one embodiment, for example, the user of virtual window 122 (FIG. 1) may use interface 210 to request to view a requested scene, e.g., a birds-eye view of scene 109. The request may also include one or more user-specified parameters relating to the view, e.g., a required zoom and the like. Upon receiving the request via interface 210, controller 204 may control transmitter 212 to transmit to image-capturing device 119 (FIG. 1), a request for the birds-eye view of scene 109 (FIG. 1) in accordance with the user-specified parameters. Upon receiving the request, image-capturing device 119 (FIG. 1) may be activated and/or adjusted to capture an image the requested view, and transmit the captured image of the requested view back to virtual window 200. Receiver 206 may receive the captured image via antenna 206. Controller 204 may receive the captured image from receiver 206, and control display 202 to display the captured image, e.g., in a window-like manner.

In one embodiment, the user of virtual window 122 (FIG. 1) may use interface 210 to request to modify one or more parameters of the requested view, e.g., to zoom-in, zoom-out, modify the pan and/or tilt of image-capturing device 119 (FIG. 1), and the like. Upon receiving the request via interface 210, controller 204 may control transmitter 212 to transmit to image-capturing device 119 (FIG. 1), a request to modify the one or more parameters. Upon receiving the adjustment request, image-capturing device 119 (FIG. 1) may modify one or more requested parameters, and transmit the adjusted image back to virtual window 200. Receiver 206 may receive the adjusted image via antenna 206. Controller 204 may receive the adjusted image from receiver 206, and control display 202 to display the adjusted image.

In one embodiment, the user of virtual window 122 (FIG. 1) may use interface 210 to request to view another, different, requested scene, e.g., a detailed view of scene 113. The request may also include one or more user-specified parameters relating to the other view, e.g., a required zoom and the like. Upon receiving the request via interface 210, controller 204 may control transmitter 212 to transmit to image-capturing device 142 (FIG. 1), a request for the detailed view of scene 113 (FIG. 1) in accordance with the user-specified parameters. Upon receiving the request, image-capturing device 142 (FIG. 1) may be activated and/or adjusted to capture an image the other requested view, and transmit the captured image of the other requested view back to virtual window 200. Receiver 206 may receive the other captured image via antenna 206. Controller 204 may receive the other captured image from receiver 206, and control display 202 to display the other captured image, e.g., in a window-like manner.

In some demonstrative embodiments, virtual window may also include a suitable storage or memory 205 to store previous scenes received by controller 204. Controller 204 may store in storage 205 received views prior to or after displaying the received views on display 202. In one embodiment, controller 204 may simultaneously receive a plurality of views, e.g., from a plurality of respective capturing devices. Controller 204 may provide a selected view of the plurality of views, e.g., based on user input from interface 210; while storing the remaining views for later use. In another embodiment, controller 204 may simultaneously provide the plurality of views to display 202, e.g., to simultaneously display a combination of the views, e.g., in the form of a plurality of virtual windows.

FIG. 3 is a schematic block diagram illustration of an image-capturing device 300 in accordance with some demonstrative embodiments. In some demonstrative embodiments, image-capturing device 300 may perform the functionality of image capturing-device 116, 126, 160, 119 and/or 142 (FIG. 1).

In some demonstrative embodiments, image-capturing device 300 may include at least one suitable camera 302 to capture images, e.g., high-definition video images. In one example, camera 302 may include one or more suitable HD video cameras, and the like. The one or more cameras 302 may be configured, oriented and/or positioned to generate suitable video data corresponding to a captured view of a scene, such that for a virtual-window, e.g., virtual window 200 (FIG. 1) may display a virtual view of the captured scene based on the video data.

In some demonstrative embodiments, image-capturing device 300 may include a controller 304 to control camera 302 to capture a requested view of a requested scene. For example, controller 304 may control one or more settings of camera 302, for example, a movement of camera 302, e.g., a pan and/or tilt; a zoom-level of camera 302; one or more image-related attributes of camera 302, e.g., a contrast, brightness, and the like; and/or any other suitable parameter or attribute of camera 302.

In some demonstrative embodiments, controller 304 may communicate with more virtual window devices using any suitable wired or wireless communication.

In some demonstrative embodiments, image-capturing device 300 may include a wireless transmitter 308 to transmit to one or more virtual windows, e.g., via one or more suitable antennas 308, signals including images captured by camera 302.

In some demonstrative embodiments, image-capturing device 300 may include a wireless receiver 310 to receive wireless transmissions from the one or more virtual windows including requests for images captured by camera 302 and/or requests to adjust and/or modify the settings of camera 302.

In some demonstrative embodiments, a virtual window system, e.g., system 100 (FIG. 1), may be capable of providing the user of a virtual window, e.g., virtual window 200 (FIG. 2), with a virtualization of any additional sensation, feeling, and/or impression corresponding to the image of the captured scene displayed by the virtual window (“the displayed scene”).

In some demonstrative embodiments, system 100 (FIG. 1) may be capable of providing the user of virtual window 200 (FIG. 2) with a sound at the displayed scene, a scent at the displayed scene, and/or any other sensation, feeling, and/or impression relating to the displayed scene.

In one embodiment, capturing device 300 may include or may be associated with a suitable audio input, e.g., a microphone 307, to capture a sound corresponding to the displayed scene, which may be provided by controller 304 to controller 204 (FIG. 2). Virtual window 200 (FIG. 2) may include or may be associated with any suitable audio output, e.g., a speaker 207 (FIG. 2), to provide the user of device 200 (FIG. 2) with the sound captured by microphone 307. For example, capturing device 300 may be positioned to capture a scene of a park, such that camera 302 may be positioned to capture a view of the park, and microphone 307 may be positioned to capture the sound of birds in the park.

In another embodiment, capturing device 300 may include or may be associated with a suitable scent capturing device 309 to capture a scent corresponding to the displayed scene, which may be provided by controller 304 to controller 204 (FIG. 2). Virtual window 200 (FIG. 2) may include or may be associated with any suitable scent generator 209 (FIG. 2) to provide the user of device 200 (FIG. 2) with the scent captured by device 309. For example, capturing device 300 may be positioned to capture a scene of a park, such that camera 302 may be positioned to capture a view of the park, and scent-capturing device 309 may be positioned to capture the scent of flowers in the park.

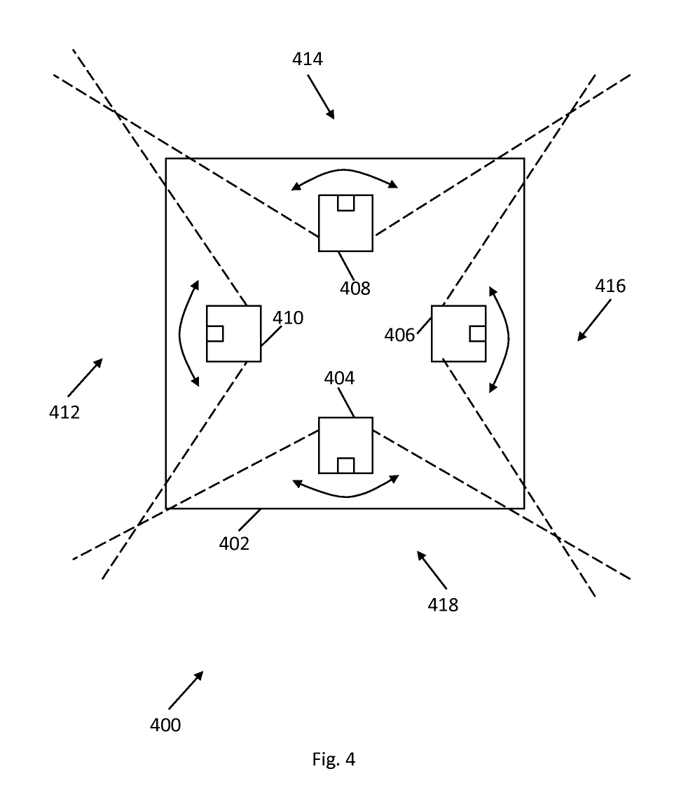

Reference is now made to FIG. 4, which schematically illustrates an image-capturing deployment scheme 400, in accordance with some demonstrative embodiments. In some demonstrative embodiments, scheme 400 may be deployed, for example, on a rooftop 402 of a building, e.g., building 102 and/or building 104 (FIG. 1) or at any other suitable location.

In some demonstrative embodiments, deployment scheme 400 may include a plurality of image-capturing devices positioned to capture different scenes and/or different views of the same scene.

In some demonstrative embodiments, deployment scheme 400 may allow capturing a relatively wide-angle field of view, for example, a field of view of substantially 360 degrees. For example, deployment scheme 400 may be deployed on rooftop 402 of a building to provide one or more virtual windows, e.g., located at various locations within or around the building, with views of substantially any location around the building.

In some demonstrative embodiments, deployment scheme 400 may include a first image-capturing device 404 positioned to capture a first field of view 418; a second image-capturing device 406 positioned to capture a first field of view 416; a third image-capturing device 408 positioned to capture a first field of view 414; and a fourth image-capturing device 410 positioned to capture a first field of view 412.

In some demonstrative embodiments, deployment scheme 400 may be implemented to provide a user of a building unit located within a building with a virtual panoramic view from the rooftop of the building. For example, one or more walls of the building unit, e.g., all four walls of a rectangular building unit, may be equipped with virtual windows to display the images captured by the four capturing devices 404, 406, 408 and 410, respectively.

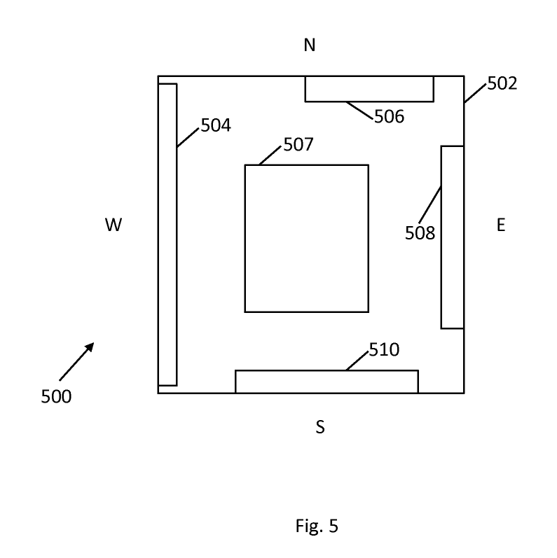

Reference is now made to FIG. 5, which schematically illustrates a virtual-window display deployment scheme 500, in accordance with some demonstrative embodiments. Deployment scheme 500 may refer, for example, to the location and positioning of one or more virtual windows within a building unit, e.g., a substantially rectangular building unit 502.

In some demonstrative embodiments, a first virtual window 504 may be deployed across substantially the entirety of a first wall of building unit 502, for example, in order to provide a user of building unit with a sense of a glass or window-like wall.

In some demonstrative embodiments, one or more virtual windows, e.g., windows 506, 508 and/or 510, may be positioned along one or more walls of building unit 502, for example, in order to provide the user of building unit with a sense of a real window in the wall. In some demonstrative embodiments, one or more virtual windows 507 may be positioned on a ceiling and/or a floor of building unit 502.

In one embodiment, one or more wall of building unit 502 may not include a portion of an external wall of a building and/or may not have a window facing out of the building. In one example, building unit 502 may include one or more external walls, which may not be equipped with windows. In another example, building unit 502 may include an inner room or an inner building unit, e.g., building unit 124 (FIG. 1). Virtual windows 504, 506, 508, 507 and/or 510 may provide the user of building unit with a sense of having one or more windows, e.g., as described above with reference to virtual window 122 (FIG. 1).

Some demonstrative embodiments of the invention, for example, may take the form of an entirely hardware embodiment, an entirely software embodiment, or an embodiment including both hardware and software elements. Some demonstrative embodiments may be implemented in software, which includes but is not limited to firmware, resident software, microcode, or the like.

Furthermore, some demonstrative embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some demonstrative embodiments, the medium may be an electronic, magnetic, optical, electromagnetic, infrared, or semiconductor system (or apparatus or device) or a propagation medium. Some demonstrative examples of a computer-readable medium may include a semiconductor or solid-state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some demonstrative embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some demonstrative embodiments, input/output or I/O devices (including but not limited to keyboards, displays, pointing devices, etc.) may be coupled to the system either directly or through intervening I/O controllers. In some demonstrative embodiments, network adapters may be coupled to the system to enable the data processing system to become coupled to other data processing systems or remote printers or storage devices, for example, through intervening private or public networks. In some demonstrative embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of embodiments of the invention have been illustrated and described herein, many modifications, substitutions, changes, and equivalents may occur to those skilled in the art. It is, therefore, to be understood that the appended claims are intended to cover all such modifications and changes.

What is claimed is:

1. A virtual window system comprising:
an image capturing device to capture a high definition video image of an outdoor view and to transmit a signal corresponding to said video image; and
at least one virtual window display positioned at an indoor location, to receive said signal from the image capturing device and, based on said signal, to display a high definition virtual, window-like, view corresponding to said outdoor view.

2. The virtual window system of claim 1, wherein the virtual view simulates a view through an actual window.

3. The virtual window system of claim 2, wherein the virtual window display is to controllably adjust the virtual view based on an orientation of a user relative to the virtual window display.

4. The virtual window system of claim 3, wherein the virtual window display includes at least one sensor to sense the orientation of the user relative to the virtual window display, and a controller to controllably adjust the virtual view based on the sensed orientation.

5. The virtual window system of claim 1, wherein the virtual view corresponds to a substantially real-time view of an outdoor scene.

6. The virtual window system of claim 1, wherein the outdoor view corresponds to an outdoor field of view in a direction from an outdoor location proximal to said indoor location.

7. The virtual window system of claim 5, wherein the virtual window display is positioned on an inner-facing surface of an enclosed structure, and wherein the capturing device is positioned on an outer-facing surface of said enclosed structure.

8. The virtual window system of claim 1, wherein the outdoor scene includes a scene viewed from another location within a radius of less than one kilometer of the indoor location.

9. The virtual window system of claim 8, wherein the image-capturing device is positioned at a location higher than the indoor location.

10. The virtual window system of claim 8, wherein the indoor location includes a first location within a building and wherein the other location includes a second location within the building.

11. The virtual window system of claim 1, wherein the at least one image capturing device includes a plurality of image capturing devices located to capture video images of a plurality of different outdoor scenes, and wherein the virtual window display includes a user interface to allow a user to select an outdoor scene to be displayed by the virtual display device.

12. The virtual window system of claim 1, wherein the virtual window display includes a user interface to allow a user to control one or more image-capturing attributes of the image-capturing device.

13. The virtual window system of claim 1, wherein the image-capturing device is to transmit the signal to the virtual window display via a wireless communication link.

14. The virtual window system of claim 1 including:
an audio input to capture a sound at the outdoor scene,
wherein the virtual window display includes an audio output to generate a sound corresponding to the sound at the outdoor scene.

15. A method of providing a virtual, window like, view of an outdoor scene, said method comprising:
capturing a high definition video image of an outdoor view of said outdoor scene;
transmitting to an indoor location a signal corresponding to said video image; and
based on said signal, display at said indoor location a high definition virtual, window-like, view corresponding to said outdoor view.

16. The method of claim 15, wherein the virtual view simulates a view through an actual window.

17. The method of claim 16 comprising controllably adjusting the virtual view based on an orientation of a user relative to a virtual window display.

18. The method of claim 15, wherein the virtual view corresponds to a substantially real-time view of an outdoor scene.

19. The method of claim 15, wherein the outdoor view corresponds to an outdoor field of view in a direction from an outdoor location proximal to said indoor location.

20. The method of claim 15, wherein the outdoor scene includes a scene viewed from another location within a radius of less than one kilometer of the indoor location.
